(19) United States
(12) Patent Application Publication
(10) Pub. No.: US 2009/0225560 A1
(43) Pub. Date: Sep. 10, 2009

(54) Aircraft External Illumination Lamp

(75) Inventors: Tomoyuki Mukai, Shizuoka (JP); Shigeo Sawada, Shizuoka (JP)

Correspondence Address: FISH & RICHARDSON P.C., P.O. BOX 1022, MINNEAPOLIS, MN, 55440-1022, US

(73) Assignee: Koito Manufacturing Co., Ltd., Tokyo (JP)

(21) Appl. No.: 12/392,138

(22) Filed: Feb. 25, 2009

(30) Foreign Application Priority Data
Mar. 6, 2008 (JP) 2008-056784

(51) Int. Cl. B64D 47/02

(52) U.S. Cl. 362/470

(57) ABSTRACT

A compact aircraft external illumination lamp has a discharge bulb as a light source that ensures a waterproof property. The aircraft external illumination lamp includes a container-shaped reflector serving also as a lamp body, a front cover attached to a front opening of the reflector, and a discharge bulb inserted in a bulb insertion hole formed in the reflector. A power supply socket is attached to a back side of the reflector so as to cover a peripheral edge of the bulb insertion hole. The power supply socket thus longitudinally fits on a plug portion of the discharge bulb which projects rearward of the bulb insertion hole, whereby electric connection with the discharge bulb is ensured. The power supply socket is structured so that a bulb activation circuit is embedded therein and a socket main body having a plug-portion fitting hole formed on a front side thereof is covered with a resin mold layer. Since the number of parts that form the illumination lamp is small, the illumination lamp can be made compact, and assembly of the illumination lamp is facilitated. The compact illumination lamp is less likely to interfere with other members, and the freedom of design choice with respect to the installation position is increased.

### CROSS-REFERENCE TO RELATED APPLICATION(S)

The present application claims the benefit of priority of Japanese Patent Application No. 2008-056784, filed on Mar. 6, 2008, the contents of which are incorporated herein by reference.

### TECHNICAL FIELD

The present disclosure relates to an aircraft external illumination lamp having a discharge bulb as a light source. More particularly, the present disclosure relates to an aircraft external illumination lamp having a waterproof structure in which a power supply socket having a discharge-bulb actuation circuit embedded therein is mounted on a plug portion located on the rear end side of a discharge bulb and projecting rearward from a bulb insertion hole of a reflector serving also as a lamp body.

### BACKGROUND

An aircraft external illumination lamp is attached to an airframe and is used to illuminate a runway during landing, to illuminate a predetermined region of a road surface for loading and unloading work, and the like. An example is disclosed in Japanese Patent Application Laid-Open (Kokai) No. 2001-266603, which discloses an aircraft searchlight in which a reflector having a discharge bulb inserted therein and a bulb actuation circuit are integrally accommodated in a cylindrically-shaped lamp body having a translucent cover attached to its front side.

However, the foregoing searchlight is structured so that the reflector having the discharge bulb inserted therein, the bulb actuation circuit, and the like are accommodated in the lamp body having a waterproof structure. Accordingly, the a large number of components are required and thus the overall size is increased.

### SUMMARY

The present invention provides a compact aircraft external illumination lamp having a discharge bulb as a light source and ensuring a waterproof property.

For example, in one aspect, an aircraft external illumination lamp includes: a container-shaped reflector serving also as a lamp body; a translucent front cover attached to a front opening of the reflector; and a discharge bulb inserted in a bulb insertion hole formed in the reflector. A power supply socket is attached to a back side of the reflector so that a peripheral edge of the power supply socket covers a peripheral edge of the bulb insertion hole. The power supply socket thus longitudinally fits on a plug portion of a rear end side of the discharge bulb which projects rearward of the bulb insertion hole, whereby electric connection with the plug portion is ensured. The power supply socket has an actuation circuit embedded therein for actuating the discharge bulb. A socket main body having a plug-portion fitting hole formed on a front side thereof is covered with a resin mold layer.

The reflector serves also as a lamp body and the discharge bulb actuation circuit is embedded in the power supply socket which is connected (e.g., fittingly mounted) to the plug portion of the discharge bulb by attaching the power supply socket to the back side of the reflector. Accordingly, the number of components of the lamp can be made smaller than that of a conventional illumination lamp, which makes the illumination lamp compact and facilitates assembly.

By pressing the power supply socket onto the reflector so that the plug-portion fitting hole of the socket main body aligns with the plug portion of the discharge bulb which projects rearward from the bulb insertion hole, the plug-portion fitting hole of the socket main body fits on the plug portion of the discharge bulb. As a result, the power supply socket (socket main body) and (the plug portion of) the discharge bulb are electrically connected to each other. The power supply socket (socket main body) and (the plug portion of) the discharge bulb are electrically disconnected from each other by removing the power supply socket from the reflector. The power supply socket can thus be attached and detached easily.

In some implementations, the peripheral edge of the bulb insertion hole is structured by a rearward extending cylindrical portion, and a peripheral edge of the power supply socket is structured so as to fit on an outer periphery of the cylindrical portion.

In some lamps, alignment between the plug-portion fitting hole in the power supply socket (socket main body) and the plug portion of the discharge bulb is difficult because it is hard to see these elements from outside. However, the plug-portion fitting hole of the socket main body fits on the plug portion of the discharge bulb simultaneously when the peripheral edge of the power supply socket is fitted onto the peripheral edge of the bulb insertion hole (e.g., a rearward extending cylindrical portion). Accordingly, the power supply socket can be assembled easily to the peripheral edge of the bulb insertion hole of the reflector without the need to visually align the plug-portion fitting hole and the plug portion of the discharge bulb.

In some implementations, the resin mold layer is made of a polyamide resin, and the peripheral edge of the power supply socket is structured by two layers, that is, an outer resin mold layer and an inner second resin layer having a higher melting point than that of the resin mold layer and having excellent heat resistance.

The power supply socket can be manufactured by an insert molding process in which resin is injected with the socket main body inserted in a mold. Since the resin mold layer covering the socket main body is made of a polyamide resin (the molding temperature is as low as about 120° C.), heat that is generated in the mold during molding of the power supply socket does not become high enough to damage the discharge bulb actuation circuit (e.g., a printed board having mounted thereon electronic parts such as a transformer, a spark gap, a capacitor, a diode, and a resistor) embedded in the socket main body.

Moreover, the inside of the peripheral edge of the power supply socket which fits on the outer periphery of the peripheral edge of the bulb insertion hole (a cylindrical portion of the reflector side) and is in direct contact with the reflector is structured by the second resin layer having a higher melting point than that of the polyamide resin and having excellent heat resistance. The heat resistant strength of the peripheral edge of the power supply socket is thus ensured.

In some implementations, the power supply socket is structured by a molded body that forms the second resin layer and a polyamide resin molded body formed by insert-molding the socket main body.

The second resin layer can be formed as a molded body before the power supply socket is formed by an insert molding process in which a polyamide resin is injected with the socket main body inserted in a mold. The second resin having a high melting point will, therefore, not be injected in the state in which the socket main body is inserted in the mold. Accordingly, heat that is generated in the mold during molding of the power supply socket (e.g., injection molding of the polyamide resin) does not become high enough to damage the discharge bulb actuation circuit (e.g., a printed board having mounted thereon electronic parts such as a transformer, a spark gap, a capacitor, a diode, and a resistor) embedded in the socket main body.

As noted above, the number of parts of the illumination lamp can be made small. This makes the illumination lamp compact and facilitates assembly of the illumination lamp. Moreover, as the illumination lamp becomes compact, the illumination lamp is less likely to interfere with other members. As a result, the degree of design choice with respect to the installation position is increased.

By fitting the peripheral edge of the power supply socket onto the peripheral edge of the bulb insertion hole (e.g., a rearward extending cylindrical portion), the socket main body of the power supply socket and the plug portion of the discharge bulb are electrically connected with each other. Accordingly, this simplifies the operation of attaching the power supply socket to the reflector.

The portion of the power supply socket which is in direct contact with the reflector of the power supply socket and is heated to a high temperature can be made of the second resin layer having excellent heat resistance. Durability of the power supply socket can, therefore, be ensured.

Preferably, the discharge bulb actuation circuit embedded in the socket main body is not affected by the heat generated during molding of the power supply socket. Accordingly, an aircraft external illumination lamp in which discharge-bulb actuation characteristics are ensured is provided.

Other features and advantages will be readily apparent from the detailed description and the accompanying drawings, and from the claims.

### BRIEF DESCRIPTION OF THE DRAWINGS

FIG. 1 is a longitudinal sectional view showing an example of an aircraft external illumination lamp according to the present invention.

FIG. 2 is an enlarged sectional view showing detail of a discharge bulb inserted in a bulb insertion hole and a power supply connecter.

FIG. 3(a) is an enlarged perspective view of a bulb fixing holding member, and FIG. 3(b) is a front view of the bulb fixing holding member.

FIG. 4 is a front view of the power supply connecter.

FIG. 5 is a block diagram showing a lighting control circuit of the illumination lamp (e.g., discharge bulb).

FIG. 6 is a structural diagram of an igniter circuit as an actuation circuit embedded in a socket main body.

### BEST MODE FOR CARRYING OUT THE INVENTION

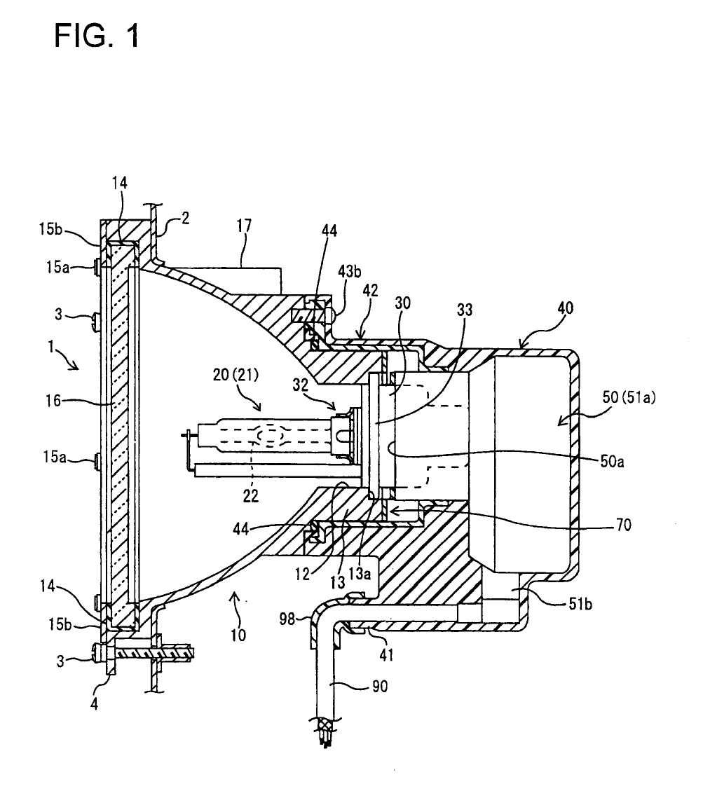

FIGS. 1 through 6 show an example of an aircraft external illumination lamp according to the present invention.

In these figures, reference numeral 1 denotes an external illumination lamp that is attached by a screw 3 to an airframe outer plate 2 of an aircraft. The external illumination lamp includes: a reflector 10 serving also as a lamp body and having a circular container shape when viewed from the front; a translucent front cover 16 attached to a front opening of the reflector 10; and a discharge bulb 20 inserted in a bulb insertion hole 12 provided at the rear top of the reflector 10. A power supply socket 40 is attached to the reflector 10 through an O-ring 44 as a sealant so as to cover a peripheral edge of the bulb insertion hole 12 located on the back side of the reflector 10, and is thus fitted on a plug portion 30 located on the rear end side of the discharge bulb 20 and projecting rearward from the bulb insertion hole 12. Electric connection between the power supply socket 40 and the plug portion 30 is thus ensured. In FIG. 1, reference numeral 4 denotes a bracket for screwing with the fitting screw 3. The bracket is provided at three positions evenly spaced apart from each other in a circumferential direction on the outer peripheral edge of the front opening of the reflector 10. Reference numeral 90 denotes an output cord that is led out from a lower end of the power supply socket 40 and extends to a ballast circuit unit 80 (see FIG. 5) fixed to the airframe 2. Reference numeral 98 denotes a tube covering an output-cord lead-out portion 41 at the lower end of the power supply socket 40. The tube can be made, for example, of a thermosetting resin and has a sealing function.

The front cover 16 can be made of glass. An annular gasket 14 having a U-shape in cross section is mounted as a sealant on the peripheral edge of the front cover 16. The front cover 16 is fixed to the front opening of the reflector 10 by an attachment frame 15b screwed 15a to the front edge of the reflector 10.

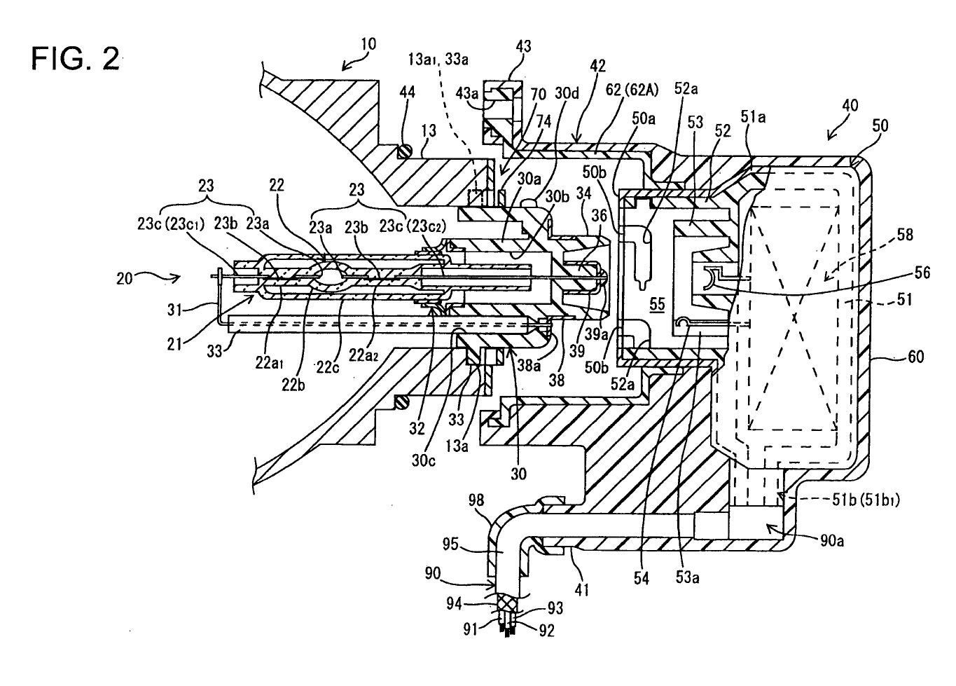

The reflector 10 can be structured by aluminum die casting. The peripheral edge of the bulb insertion hole 12 located on the back side of the reflector 10 is structured by a cylindrical portion 13, and a cylindrical peripheral edge 42 on the front side of the power supply socket 40 is fitted on the cylindrical portion 13. An annular stepped portion 13a (see FIGS. 1 and 2) is formed on the inner peripheral side of an end of the cylindrical portion 13, and a focus ring 33 of the discharge bulb 20 side engages in the annular stepped portion 13a in a circumferentially aligned manner. On the back side of the reflector 10 are provided heat release fins 17 projecting from the reflector 10. The heat release fins 17 are provided at predetermined intervals in a lateral direction (a direction vertical to the plane of the paper of FIG. 1), whereby heat that is generated by light emission of the discharge bulb 20 can be released through the reflector 10.

As shown in the enlarged view of FIG. 2, the discharge bulb 20 is formed by integrating an arc tube main body 21 with the insulating plug portion 30 made of a polyphenylene sulfide (PPS) resin having excellent heat resistance. The arc tube main body 21 is supported at its both ends by a lead support 31 extending forward from the substantially cylindrical insulating plug portion 30 and a metal support member 32 provided on the front side of the insulating plug portion 30. Reference numeral 33 denotes a ceramic insulating sleeve though which the lead support 31 is inserted. The insulating sleeve 33 is inserted in an insertion hole 30c formed on the front side of the insulating plug portion 30.

The arc tube main body 21 is structured so that a cylindrical ultraviolet shielding shroud glass 22c is integrally welded (i.e., sealed) to a quartz glass arc tube 22. The quartz glass arc tube 22 has tungsten electrode rods 23a provided therein so as to face each other, and has a sealed glass bulb 22b as a discharging light source in which a metal halide or the like as a light-emitting material is enclosed together with a starting rare gas. Each electrode rod 23a is connected integrally with a molybdenum foil 23b and a molybdenum lead wire 23c (23c1, 23c2) and is thus structured as an electrode assembly 23. The electrode assemblies 23 are sealed in respective pinch seal portions 22a1, 22a2 so that the electrode rods 23a project in the sealed glass bulb 22b. The lead wire 23c1 of the front end side which is led out from the pinch seal portion 22a1 of the front end side is welded to a bent tip portion of the lead support 31. The lead support 31 has its rear end welded to a flange portion 38a of a belt-type terminal 38 provided on the outer periphery of the rear end side of the insulating plug portion 30. The lead wire 23c2 of the rear end side which is led out from the pinch seal portion 22a2 of the rear end side, on the other hand, is welded to a cap-type terminal 39 provided in the middle of the rear end of the insulating plug portion 30.

A recess 30b surrounded by a partition wall 30a is formed on the front end side of the insulating plug portion 30 in order to accommodate the rear end of the arc tube main body 21. The focus ring 33 that engages with the annular stepped portion 13a of the bulb insertion hole 12 side in a circumferentially aligned state is disposed on the outer periphery of the insulating plug portion 30. This circumferential alignment is structured by a projecting portion 13a1 formed in the annular stepped portion 13a and a notch 33a formed in the peripheral edge of the focus ring 33. For example, the projecting portion 13a1 and the notch 33a engage with each other in an extending direction of the bulb insertion hole 12 (i.e., the lateral direction in FIG. 2). The focus ring 33 engaging with the annular stepped portion 13a by inserting the discharge bulb 20 into the bulb insertion hole 12 from the back side of the reflector 10 is fixedly held by a bulb fixing holding plate 70 screwed (screws are not shown) to an end face of the cylindrical portion 13.

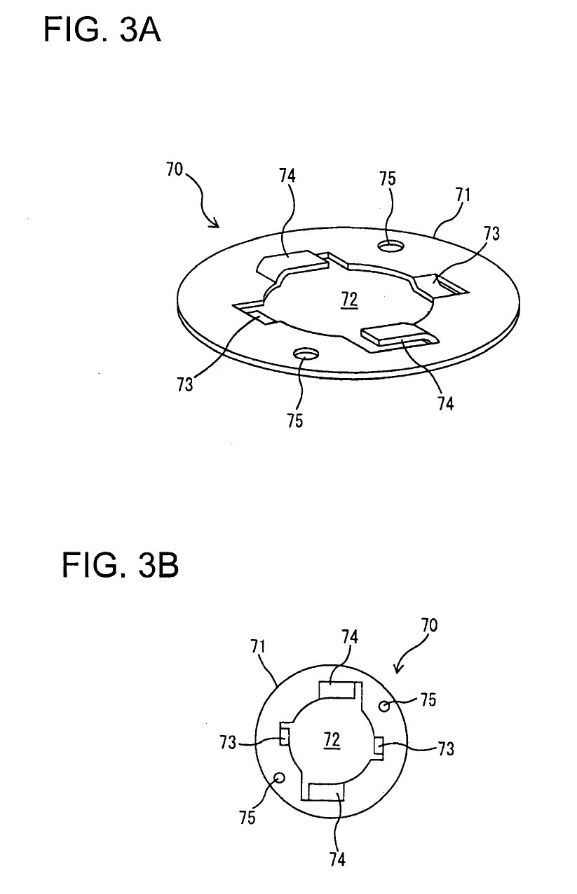

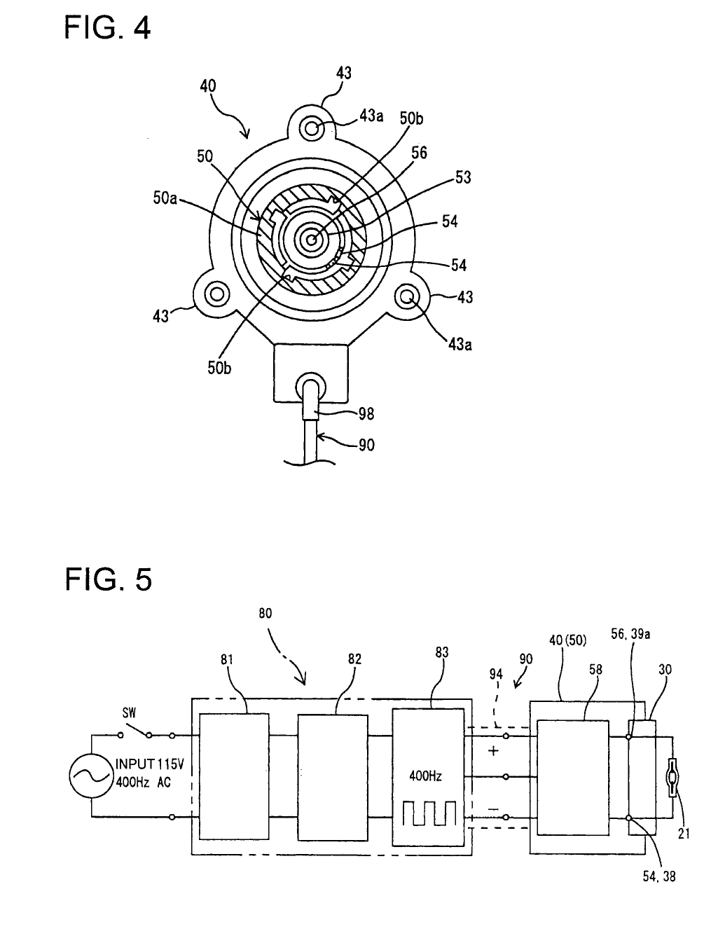

As shown in the enlarged views of FIG. 3A and FIG. 3B, the bulb fixing holding plate 70 is structured by a stainless-steel disc-shaped plate main body 71 having a circular hole 72 formed in the middle for insertion of the plug portion. A pair of elastic tongue pieces 73 cut and raised to the front side (i.e., the lower side in FIG. 3(a)) and a pair of elastic tongue pieces 74 cut and raised to the back side (i.e., the upper side in FIG. 3(a)) are provided on the inner peripheral edge side of the plate main body 71 at such positions that the line connecting the pair of elastic tongue pieces 73 and the line connecting the pair of elastic tongue pieces 74 cross perpendicularly to each other when viewed from the front. Reference numeral 75 denotes an insertion hole for a fastening screw (not shown). When the bulb fixing holding plate 70 is screwed to the end face of the cylindrical portion 13, the pair of elastic tongue pieces 73 cut and raised to the bulb insertion hole 12 side hold the focus ring 33 of the plug portion 30 while pressing the focus ring 33 against the annular stepped portion 13a. The discharge bulb 20 is thus fixedly held in the bulb insertion hole 12. The pair of elastic tongue pieces 74 cut and raised to the rear side of the reflector 10, on the other hand, are brought into press-contact with a front edge 50a (shown by a shaded part in FIG. 4) of a socket main body 50 in the power supply socket 40 described below when the peripheral edge 42 of the power supply socket 40 is fitted on the cylindrical portion 13 of the reflector 12 side.

On the rear end side of the insulating plug portion 30 is formed a columnar boss 36 inside a rearward-extending cylindrical outer cylinder portion 34. The belt-type terminal 38 conducting with the lead support 31 is provided on the outer periphery of the root portion of the outer cylinder portion 34. The columnar boss 36, on the other hand, is covered by the cap-type terminal 39. The lead wire 23c2 of the rear end side which is led out from the arc tube main body 21 extends through the columnar boss 36 and is connected to the cap-type terminal 39. Reference numeral 39a denotes a terminal projection as a laser welded portion.

The power supply socket 40 has an igniter circuit 58 embedded therein as an actuation circuit for actuating the discharge bulb 20. The power supply socket 40 is structured so that the socket main body 50 having a plug-portion fitting hole 55 on its front side is covered with a resin mold layer 60. The peripheral edge 42 on the front side of the power supply socket 40 is formed in a cylindrical shape that axially fits on the outer periphery of the columnar portion 13 of the reflector 10 side. Three brackets 43 each having a screw insertion hole 43a is formed on the outer periphery of the front end of the peripheral edge 42. The power supply socket 40 can thus be fixed to the back side of the reflector 10 by fitting screws 43b (see FIG. 1).

The resin mold layer 60 can be made of a polyamide resin (e.g., having a molding temperature of about 120° C.) so that the igniter circuit 58 embedded in the socket main body 50 is not damaged by heat that is generated during molding of the resin mold layer 60.

More specifically, the power supply socket 40 can be manufactured by an insert molding process in which resin is injected with the socket main body 50 inserted in a mold. Since the resin mold layer 60 covering the socket main body 50 is made of a polyamide resin (e.g., for which the molding temperature is as low as about 120° C.), heat that is generated in the mold during molding of the power supply socket 40 does not become high enough to damage electronic parts of the igniter circuit 58 embedded in the socket main body 50.

The cylindrical peripheral edge 42 of the power supply socket 40 which fits on the outer periphery of the cylindrical portion 13 of the reflector 10 side is structured by the outer polyamide resin layer 60 and an inner second resin (e.g., PPS) layer 62 having a higher melting point than that of the polyamide resin and having excellent heat resistance and excellent mechanical strength. The heat resistant strength and the assembly strength of (the peripheral edge 42 of) the power supply socket 40 are thus ensured. The power supply socket 40 can be molded by first preparing as the inner second resin (e.g., PPS) layer 62 a PPS molded body 62A formed in a predetermined cylindrical shape by an injection molding process, and then performing an insertion molding process in which a polyamide resin is injected with the socket main body 50 and the PPS molded body 62A being inserted in a mold. As described above, the igniter circuit 58 embedded in the socket main body 50 will not be affected by heat that is generated during injection molding of the power supply socket 40. The socket main body 50 is structured so that a PPS case 51 accommodating the igniter circuit 58 is covered by an aluminum thin plate cover body 51a. On the front side of the socket main body 50, the plug-portion fitting hole 55 in which the rear end side of the plug portion 30 of the discharge bulb 20 can be engaged in an axial direction is formed by a cylindrical outer cylinder portion 52 and a cylindrical inner cylinder portion 53 which are integrally formed in the case 51. The aluminum thin plate cover body 51a is molded integrally by a press molding process so as to cover the PPS case 51, and the aluminum thin plate extends to the front end face of the outer cylinder portion 52 (i.e., the front edge 50a of the socket main body 50).

A part of the inner cylinder portion 53 in a circumferential direction is notched in an axial direction. A tongue-shaped contact terminal 54 (a terminal of the igniter circuit 58 side) which extends in an axial direction so as to be in press-contact with the belt-type terminal 38 of the plug portion 30 side of the discharge bulb 20 is provided in the notch 53a. A contact terminal 56 (a terminal of the igniter circuit 58 side) which is in press-contact with the terminal projection 39a of the cap-type terminal 39 of the plug portion 30 side of the discharge bulb 20 is provided at the bottom of the plug-portion fitting hole 55.

As shown in FIG. 4, notches 50b respectively connecting to L-shaped guide grooves 52a (see FIG. 2) formed in the inner peripheral surface of the outer cylinder portion 52 are provided at four positions evenly spaced apart from each other in a circumferential direction in the front edge 50a of the socket main body 50. A pair of pins 30d (see FIG. 2) capable of engaging in the L-shaped guide grooves 52a of the outer cylinder portion 52 side are provided on the outer periphery of the plug portion 30 of the discharge bulb 20. By engagement between the L-shaped guide grooves 52a and the pins 30d, the socket main body 50 is prevented from being detached from the plug portion 30 of the discharge bulb 20.

By pressing the power supply socket 40 onto the reflector 10 so that the plug-portion fitting hole 55 of the socket main body 50 is aligned with the plug portion 30 of the discharge bulb 20 projecting rearward from the bulb insertion hole 12, the front edge 50a of the socket main body 50 abuts on the pins 30d of the plug portion 30 side. In this state, by rotating the power supply socket 40 with respect to the plug portion 30, the notches 50b in the front edge 50a of the socket main body 50 engage with the pins 30d of the plug portion 30 side. In this state, by further pressing the power supply socket 40 onto the reflector 10 and rotating the power supply socket 40 counterclockwise, the pins 30d and the L-shaped guide grooves 52a are brought into bayonet engagement. At this time, the plug-portion fitting hole 55 of the socket main body 50 reliably fits on the rear end side of the plug portion 30 of the discharge bulb 20, and the contact terminal 54 and the contact terminal 56 of the igniter circuit 58 of the socket main body 50 side are respectively in contact with the belt-type terminal 38 and the terminal projection 39a of the plug portion 30 side of the discharge bulb 20. The power supply socket 40 (the socket main body 50) and the plug portion 30 of the discharge bulb 20 are thus electrically connected to each other.

Alignment between the plug-portion fitting hole 55 in the power supply socket 40 and the plug portion 30 of the discharge bulb 20 is especially difficult because it is hard to see these elements from outside. However, the plug-portion fitting hole 55 of the socket main body 50 fits on the plug portion 30 of the discharge bulb 20 simultaneously when the peripheral edge 42 of the power supply socket 40 is fitted onto the outer periphery of the cylindrical portion 13 on the back side of the reflector 10. Accordingly, the power supply socket 40 can be assembled easily to the back side of the reflector 10 without the need to visually align the plug-portion fitting hole 55 and the plug portion 30 of the discharge bulb 20.

As shown in FIG. 5, a lighting control circuit of the discharge bulb 20 is structured by an AC/DC converter 81 connected to a 115 v, 400 Hz alternating-current power supply through a switch Sw, a DC/DC converter 82 connected to the AC/DC converter 81, an inverter 83 connected to the DC/DC converter 82, and an igniter circuit 58 connected to the inverter 83. A direct current of 400 Hz is supplied to the terminals 38, 39 (39a) of the plug portion 30 side of the discharge bulb 20 through the terminals 54, 56 of the power supply socket 40 (socket main body 50) side. The AC/DC converter 81, the DC/DC converter 82, and the inverter 83 are integrated as the ballast circuit unit 80.

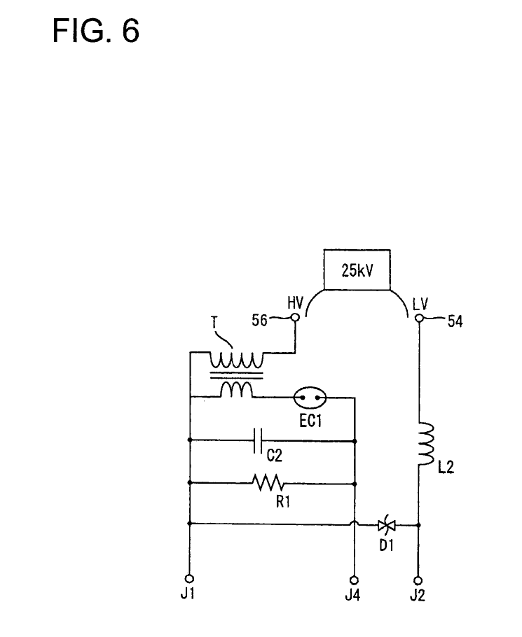

As shown in FIG. 6, the igniter circuit 58 is structured by electronic parts such as a transformer T, a spark gap EC1, a capacitor C2, a resistor R1, a diode D1, and a coil L and has three inputs, that is, direct-current±(J1, J2) and a trigger line J4. When a voltage applied to the spark gap EC1 between J1 and J4 exceeds 800 V, charges accumulated in the capacitor C2 are discharged and a voltage as high as 25 KV is provided between a high-voltage-side terminal HV (i.e., the terminal 56 in the socket main body 50 and the terminal 39a of the plug portion 30 side) and a low-voltage-side terminal LV (i.e., the terminal 54 in the socket main body 50 and the terminal 38 of the plug portion 30 side).

As shown in FIG. 2, the output cord 90 connecting the power supply connecter 40 (the igniter circuit 58 in the socket main body 50) and the ballast circuit unit 80 (see FIG. 5) is structured so that three power supply lines 91, 92, 93 covered with an insulating resin are covered with a metal shield covering layer 94 and a resin external covering layer 95. One end of the output cord 90 is connected to a connecter connection portion 51b of the power supply socket 40 (the socket main body 50) through a connector 90a, and the other end of the output cord 90 is connected to a connector connection portion (not shown) of the ballast circuit unit 80 side through a connecter (not shown). One end of the metal shield covering layer 94 is solder-welded to an outer-shell portion 51b1 of the connecter connection portion 51b as a part of the aluminum thin plate cover body 51a that forms an outer shell of the socket main body 50 of the power supply socket 40 side. The other end of the metal shield covering layer 94 is connected to an earth terminal of the ballast circuit unit 80 side which conducts with the airframe 2. The metal shield covering layer 94 thus forms a part of a transmission path of electromagnetic waves generated in the discharge bulb 20.

In other words, when the peripheral edge 42 of the power supply socket 40 is attached to the back side of the reflector 10 so as to fit on the outer periphery of the cylindrical portion 13, conduction between the aluminum die-cast reflector 10 and the aluminum thin plate cover body 51a (which forms the outer shell of the socket main body 50 in the power supply socket 40) is ensured through the elastic tongue pieces 74 of the stainless-steel bulb fixing holding ring 70. The connecter connection portion 51b as a part of the aluminum thin plate cover body 51a, on the other hand, is connected through the metal shield covering layer 94 of the output cord 90 to the earth terminal (not shown) of the ballast circuit unit 80 side which conducts with the airframe 2. Therefore, the illumination lamp 1 has an electromagnetic-wave shielding structure in which electromagnetic waves generated in the discharge bulb 20 will not be transmitted to the airframe 2 through the foregoing transmission path and, thus, electromagnetic interference will not occur.

Other implementations are within the scope of the claims.

What is claimed is:

1. An aircraft external illumination lamp comprising:
a container-shaped reflector serving as a lamp body;
a translucent front cover attached to a front opening of the reflector;
a discharge bulb inserted in a bulb insertion hole in the reflector; and
a power supply socket attached to a back side of the reflector so that a peripheral edge of the power supply socket covers a peripheral edge of the bulb insertion hole, and the power supply socket thus longitudinally fits on a plug portion of a rear end side of the discharge bulb which projects rearward of the bulb insertion hole to provide electric connection with the plug portion,
wherein the power supply socket has an actuation circuit embedded therein for actuating the discharge bulb, and wherein a socket main body having a plug-portion fitting hole on a front side thereof is covered with a resin mold layer.

2. The aircraft external illumination lamp according to claim 1, wherein the peripheral edge of the bulb insertion hole includes a rearward extending cylindrical portion, and the peripheral edge of the power supply socket is arranged so as to fit on an outer periphery of the cylindrical portion.

3. The aircraft external illumination lamp according to claim 1 wherein the resin mold layer is made of a polyamide resin, and wherein the peripheral edge of the power supply socket has two layers including an outer resin mold layer and an inner second resin layer having a melting point higher than that of the outer resin mold layer.

4. The aircraft external illumination lamp according to claim 3 wherein the power supply socket includes a molded body that forms the second resin layer and a polyamide resin molded body formed by insert-molding the socket main body.

5. The aircraft external illumination lamp according to claim 2 wherein the resin mold layer is made of a polyamide resin, and wherein the peripheral edge of the power supply socket has two layers including an outer resin mold layer and an inner second resin layer having a melting point higher than that of the outer resin mold layer.

6. The aircraft external illumination lamp according to claim 5 wherein the power supply socket includes a molded body that forms the second resin layer and a polyamide resin molded body formed by insert-molding the socket main body.
